(19) United States
(12) Patent Application Publication
(10) Pub. No.: US 2004/0123703 A1
(43) Pub. Date: Jul. 1, 2004

(54) Handle for hand tools

(76) Inventor: Chih-Ching Hsien, Taichung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/331,462

(22) Filed: Dec. 31, 2002

(51) Int. Cl. B25B 23/16

(52) U.S. Cl. 81/177.1

(57) ABSTRACT

A hand tool includes a handle having a function end connected to one of two ends of the handle and a through hole is defined through the handle. The through hole is defined by two serrated insides.

### FIELD OF THE INVENTION

The present invention relates to a handle of a hand tool and the handle includes a through hole or recess that is defined by serrated sides so that the user's hand may insert the through hole or recess to operate the tool.

### BACKGROUND OF THE INVENTION

A conventional hand tool such as a wrench generally includes a handle and at least one open end or a box end connected to an end of the handle. The hand tool is operated by mounting the open end or the box end to an object such as a nut or a bolt head, and rotating the handle to loosen or tighten the nut or the bolt head. Nevertheless, in a work site, the handle of the hand tool is usually attached with lubricant or oil so that the user has to grasp firmly to operate the tool. This is especially difficult when the nut or the bolt head is so tightened or get rusted, the user has to exert a large force to rotate the handle. It is slippery for the hand holding at the flat or smooth surface of the handle on which oil is attached.

The present invention intends to provide a handle of a hand tool and the handle has a through hole with serrated insides so that the user's fingers can hold the serrated insides and rotate the handle.

### SUMMARY OF THE INVENTION

In accordance with one aspect of the present invention, there is provided a hand tool which includes a handle having a function end connected to one of two ends of the handle and a through hole is defined through the handle. The through hole is defined by two serrated insides.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1-1 is a perspective view to show the hand tool of the present invention;

FIG. 1-2 is a cross sectional view to show the handle of the hand tool of the present invention;

FIG. 2 is a perspective view to show the hand tool of the present invention;

FIG. 3 shows the number of the through hole is two in the handle of the hand tool of the present invention;

FIG. 4 shows the number of the through hole is three in the handle of the hand tool of the present invention;

FIG. 5 shows different types of the handle of the hand tool of the present invention;

FIGS. 6 and 7 show top views of two hand tools of the present invention;

FIG. 8 shows a user's hands grasping the through hole of the handle of the hand tool of the present invention;

FIG. 9 shows another embodiment of the hand tool of the present invention;

FIG. 10 is a cross sectional view of the handle as shown in FIG. 9, and

FIG. 11 shows a user's hands grasping the recess in the handle of the hand tool of the present invention.

### DETAILED DESCRIPTION OF THE PREFERRED EMBODIMENT

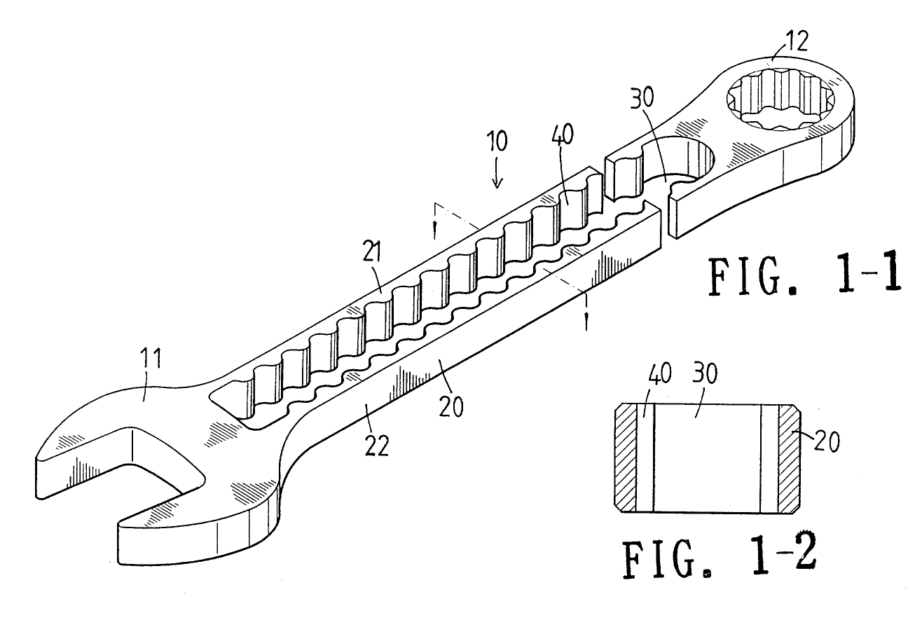

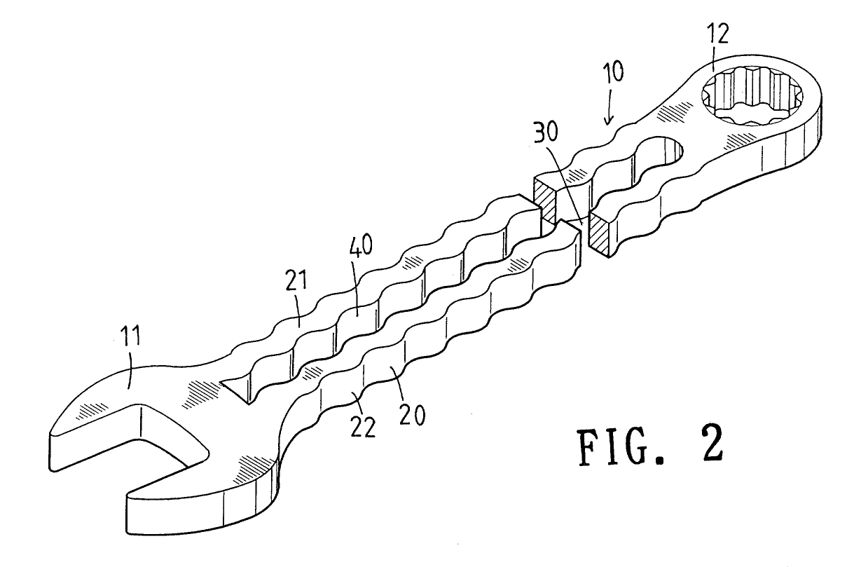

Referring to FIGS. 1-1 and 1-2, the hand tool 10 of the present invention comprises a handle 20 having two function ends connected to two ends of the handle 10, the function ends can be open end 11 and a box end 12. The handle 20 includes two wide opposite surfaces 21 and two narrow opposite surfaces 22, a through hole 30 is defined through the two wide opposite surfaces 21. The through hole 30 is defined by two serrated insides which wave-shaped insides 40.

As shown in FIG. 8, the user may insert his hands in the through hole 30 and the fingers grasp the wave-shaped insides 40. The fingers can grasp the handle 20 firmly so as to rotate the handle 20.

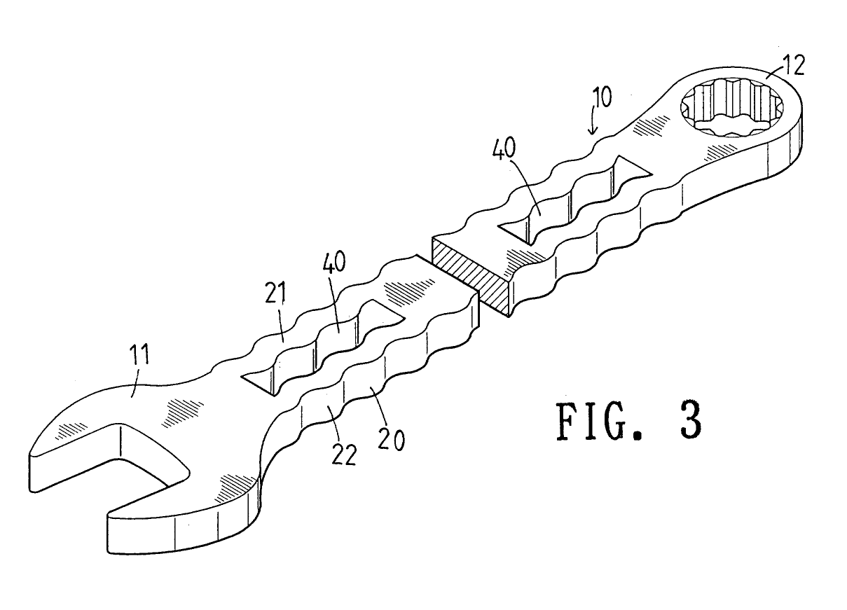

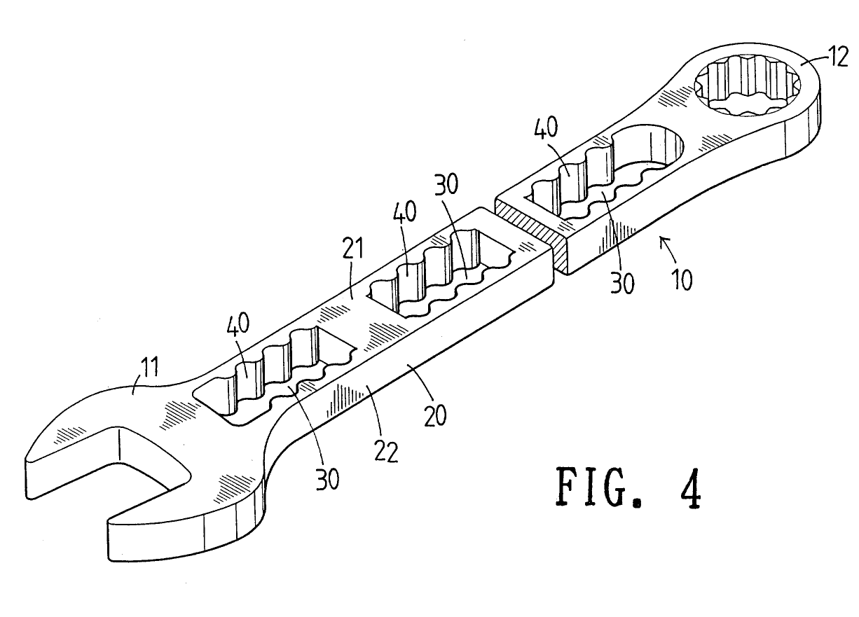

As shown in FIG. 2 the two narrow opposite surfaces 20 can also be made to be serrated surfaces. As shown in FIGS. 3 and 4, the number of the through holes 40 can be two or three.

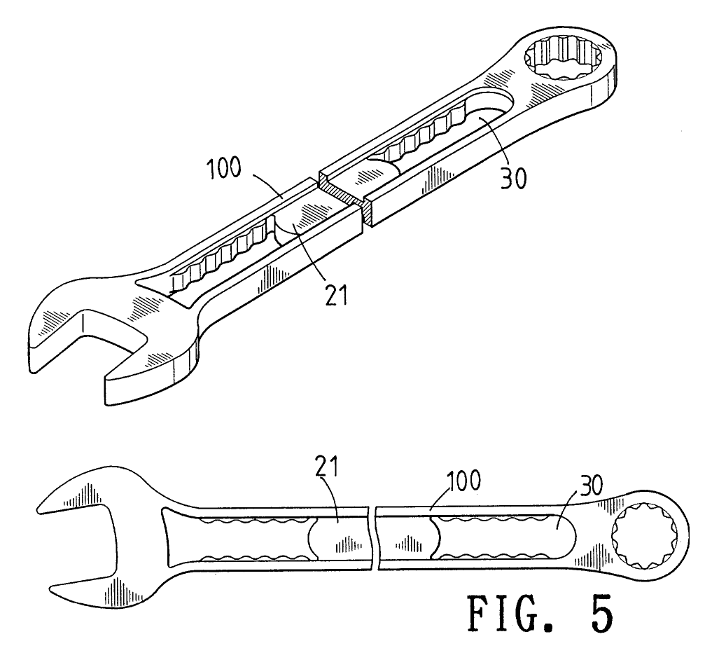

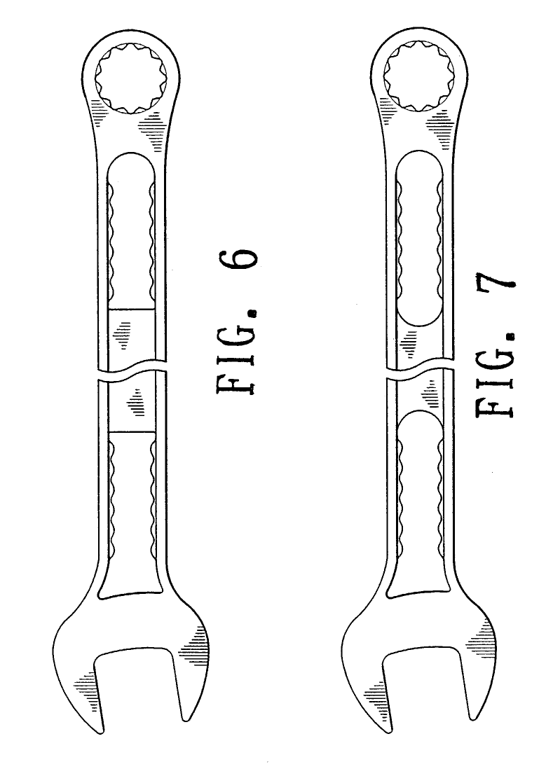

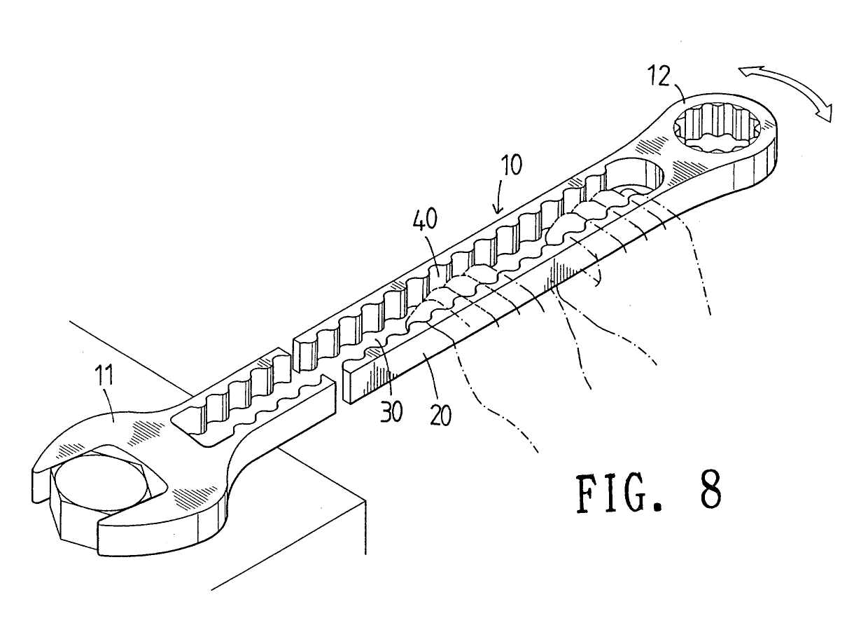

Referring to FIGS. 5 to 7, two flanges 100 extend from two sides of the two opposite wide surfaces 21 of the handle 20 such that the structural strength of the handle 20 is improved.

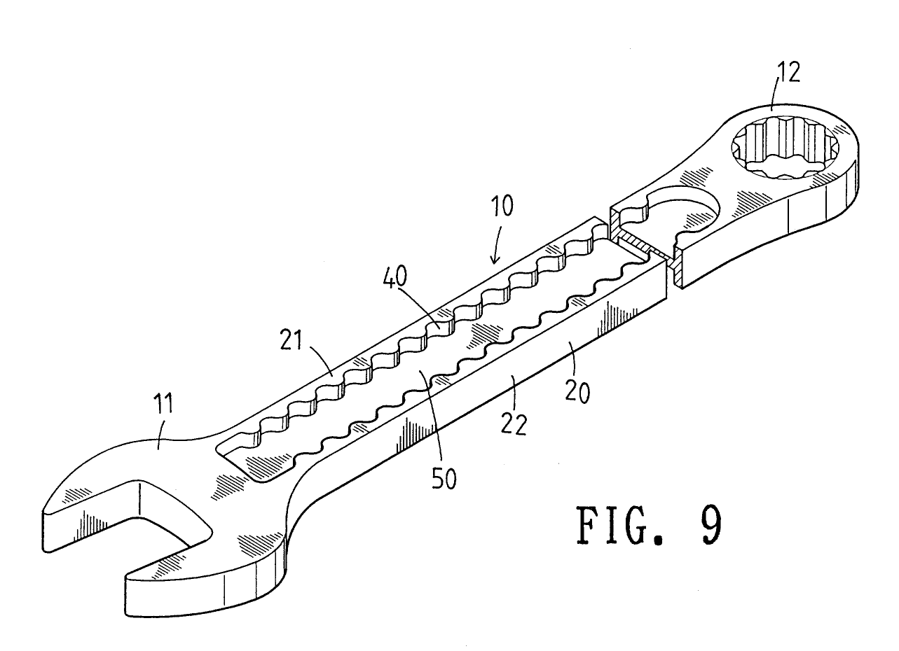

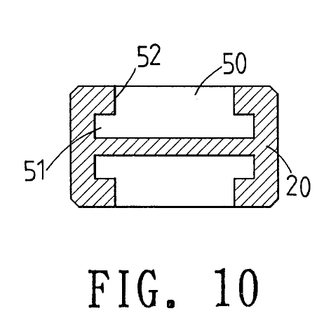

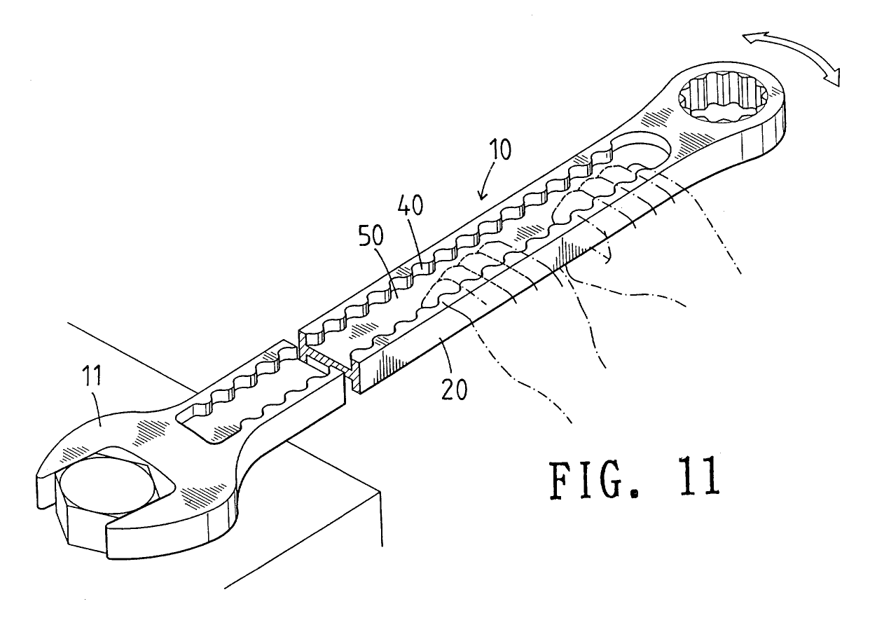

Referring to FIGS. 9 to 11, two recesses 50 are defined in the two wide opposite surfaces 21 of the handle 20 and each recess 50 has wave-shaped insides 40 so that the fingers of the user can hold the handle 20 firmly. A flange 52 extends from each of two insides defining each of the recesses 50 so as to define a recessed area 51 in which the fingers may insert.

While we have shown and described the embodiment in accordance with the present invention, it should be clear to those skilled in the art that further embodiments may be made without departing from the scope of the present invention.

What is claimed is:

1. A hand tool comprising:
a handle having a function end connected to one of two ends of the handle, and
at least one through hole defined through the handle and defined by two serrated insides.

2. The hand tool as claimed in claim 1, wherein the serrated insides are wave-shaped insides.

3. The hand tool as claimed in claim 1, wherein the handle includes two wide opposite surfaces and two narrow opposite surfaces, the at least one through hole defined through the two wide opposite surfaces.

4. The hand tool as claimed in claim 3, wherein the two narrow opposite surfaces are serrated surfaces.

5. A hand tool comprising:
a handle having a function end connected to one of two ends of the handle, and
two recesses defined in two opposite surfaces of the handle.

6. The device as claimed in claim 5 further comprising a flange extending from each of two insides defining each of the recesses.

7. The hand tool as claimed in claim 5, wherein the handle includes two wide opposite surfaces and two narrow opposite surfaces, the two recesses defined in the two wide opposite surfaces.
